(19) United States
(12) Patent Application Publication
(10) Pub. No.: US 2021/0051262 A1
(43) Pub. Date: Feb. 18, 2021

(54) CAMERA DEVICE AND FOCUS METHOD

(71) Applicant: SZ DJI TECHNOLOGY CO., LTD., Shenzhen (CN)

(72) Inventor: Mingyu WANG, Shenzhen (CN)

(21) Appl. No.: 17/084,409

(22) Filed: Oct. 29, 2020

Related U.S. Application Data
(63) Continuation of application No. PCT/CN2018/102912, filed on Aug. 29, 2018.

(51) Int. Cl. H04N 5/232; G06T 7/73; G06T 7/593; H04N 13/239; H04N 13/296; G06K 9/62; G06T 7/30; H04N 5/247

(52) U.S. Cl. CPC H04N 5/23212; G06T 7/74; G06T 7/593; H04N 13/239; H04N 2013/0081; G06K 9/6217; G06K 9/6201; G06T 7/30; H04N 5/247; H04N 13/296

(57) ABSTRACT

A focus method includes controlling binocular cameras of a camera device to capture binocular images of a target scene during a process of photographing the target scene using a main camera of the camera device, determining positions of a target area of the target scene in the binocular images, determining distance information of the target area according to the positions of the target area in the binocular images, and controlling the main camera to perform focus according to the distance information of the target area.

### CROSS-REFERENCE TO RELATED APPLICATION

This application is a continuation of International Application No. PCT/CN2018/102912, filed Aug. 29, 2018, the entire content of which is incorporated herein by reference.

### TECHNICAL FIELD

The present disclosure generally relates to the camera field and, more particularly, to a camera device and a focus method.

### BACKGROUND

With the development of the camera technology, camera device is broadly used in various fields, such as mobile terminal field and unmanned aerial vehicle (UAV) field.

When a camera device is used to photograph a target scene (i.e., to-be-photographed scene), a focus needs to be performed. Currently, the camera device usually uses an automatic focusing manner to perform the focus. However, the conventional automatic focusing manner may be low efficient and have a poor focusing effect, which is desired to be improved.

### SUMMARY

Embodiments of the present disclosure provide a focus method. The method includes controlling binocular cameras of a camera device to capture binocular images of a target scene during a process of photographing the target scene using a main camera of the camera device, determining positions of a target area of the target scene in the binocular images, determining distance information of the target area according to the positions of the target area in the binocular images, and controlling the main camera to perform focus according to the distance information of the target area.

Embodiments of the present disclosure provide a camera device including a main camera, binocular cameras, and a control device. The control device is configured to control the binocular cameras to capture binocular images of a target scene during a process of photographing the target scene using the main camera, determine positions of a target area of the target scene in the binocular images, determine distance information of the target area according to the positions of the target area in the binocular images, and control the main camera to perform focus according to the distance information of the target area.

### BRIEF DESCRIPTION OF THE DRAWINGS

FIG. 1 is a schematic structural diagram of a camera device according to some embodiments of the present disclosure.

FIG. 2 is a schematic flowchart showing a focus method according to some embodiments of the present disclosure.

FIG. 3 is a schematic diagram showing an image captured by the camera device according to some embodiments of the present disclosure.

FIG. 4 is a schematic flowchart of a possible implementation of process S24 in FIG. 2.

FIG. 5 is a schematic flowchart of another possible implementation of process S24 in FIG. 2.

### DETAILED DESCRIPTION OF THE EMBODIMENTS

To facilitate understanding, focus technology is briefly described first.

Focus may also be referred to as light converging or focal point alignment. A focusing process refers to a process of adjusting a focal point during use of a camera device to cause an image of a photographed object to gradually become clear.

To facilitate use for a user, a camera device mainly uses auto focus (AF) technology to perform focus. The AF technology may include active AF and passive AF.

The active AF may be referred to as range-finder focus. When the active AF is used to perform focusing, the camera device may transmit a ranging signal (e.g., infrared, ultrasound, or laser) to a photographed object. Then, the camera device may receive an echo of the ranging signal reflected by the photographed object. As such, the camera device may calculate a distance to the photographed object according to the echo signal and interfere with the focusing process of the camera device according to the distance to the photographed object.

The distance measured by an active AF manner is usually a distance of an object in a photographed scene nearest to the camera device. Therefore, the conventional active AF manner may not focus on a distant object, which may limit an application scene for such a focusing manner. Thus, the current camera device uses mainly a passive AF manner to perform the focus.

The passive AF may also be referred to as lens-behind focus. The passive AF may include contrast detection AF (CDAF) and phase detection AF (PDAF).

The CDAF may be simply called a contrast focus. For the contrast focus, a lens position with the highest contrast, which is an accurate focus position, may be searched for according to a contrast change of the image at the focal point. With the contrast focus, the lens may need to move repeatedly and cannot reach the accurate focus position at one time, thus, the focusing process is slow.

The PDAF may be simply called phase focus. For the phase focus, some shielded pixels at the photosensitive element are reserved to be used as phase focal points, which may be used to perform phase detection. In the focusing process, the camera device may determine a focus offset value according to distances between the phase focal points and their changes to realize the focus. The phase focus may be limited to the strength of the signal at the phase focal points of the photosensitive element, which may have a poor focus effect in a dark environment.

In summary, the above-described focus manners may cause the camera device to have a low focus efficiency or poor focus effect, which needs to be improved. The camera device and focus method of embodiments of the present disclosure are described in detail in connection with the accompanying drawings.

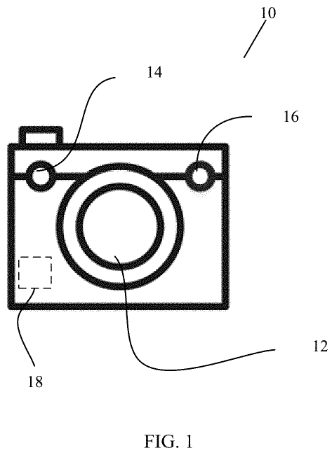

FIG. 1 is a schematic structural diagram of a camera device 10 according to some embodiments of the present disclosure. As shown in FIG. 1, the camera device 10 includes a main camera 12, binocular cameras 14 and 16, and a control device 18.

The main camera 12 may be configured to capture an image (e.g., plane image) of a target scene (or a photographed scene). The main camera 12 may include a lens, a focus system (not shown in FIG. 1), etc. In some embodiments, the main camera 12 may include a display screen (e.g., a liquid crystal display (LCD) screen). The user may capture and present the target scene, at which the lens is aimed, through the display screen. Further, the display screen may be a touch screen. The user may select a to-be-focused area (also referred to as a “target area”) of the image displayed in the LCD screen through a touch operation (e.g, click or slide).

The binocular cameras 14 and 16 may also be referred to as a binocular visual module or binocular module. The binocular cameras 14 and 16 includes a first camera 14 and a second camera 16. The binocular cameras 14 and 16 may be configured to assist the main camera 12 to perform fast focus. For example, the binocular cameras 14 and 16 may be controlled by the control device 18 to capture binocular images (including a left-eye image and a right-eye image) of the target scene and perform a depth analysis on the target scene according to the binocular images (or parallax between the binocular images). Then, the binocular cameras 14 and 16 may provide distance information of the to-be-focused area for the main camera 12 to cause the main camera 12 to perform the focus with the known distance of the to-be-focused area.

The binocular cameras 14 and 16 and the main camera 12 may be integrated at the camera device 10 (e.g., a housing of the camera device 10). That is, the binocular cameras 14 and 16 and the main camera 12 may be fixedly connected to form a non-detachable whole.

In some other embodiments, the binocular cameras 14 and 16 may also be detachably connected to the main camera 12. In this situation, the binocular cameras 14 and 16 may be considered as peripheral components of the main camera 12. When the binocular cameras 14 and 16 are needed to assist the focus, the binocular cameras 14 and 16 may be assembled with the main camera 12 together for use. When the binocular cameras 14 and 16 are not needed to assist the focus, the binocular cameras 14 and 16 may be detached from the main camera 12, and the main camera 12 may be used as a normal camera.

In embodiments of the present disclosure, position relationship between the main camera 12 and the binocular cameras 14 and 16 may not be limited. So long as the position relationship between the main camera 12 and the binocular cameras 14 and 16 is set for them to capture a scene with a substantially same field of view.

Since the binocular cameras 14 and 16 and the main camera 12 are located at the same camera device 10, the parallaxes between them are usually very small. Thus, an object in the image captured by the main camera 12 may be considered to appear in the binocular images captured by the binocular cameras 14 and 16. The image captured by the main camera 12 is also referred to as a “main image.” The images captured by the main camera 12 and the binocular cameras 14 and 16 may be used directly without registration or correction.

In some other embodiments, to improve the accuracy of the focus, the correction or registration may be performed on the images captured by the main camera 12 and the binocular cameras 14 and 16 to ensure that the image content of the image captured by the main camera 12 may be in the binocular images.

For example, the registration may be performed on the image captured by the main camera 12 and the binocular images according to differences of the fields of view of the main camera 12 and the binocular cameras 14 and 16. The registered images may be then used to perform a focusing operation. The image contents of the registered images may be common areas of the image captured by the main camera and the binocular images.

For example, compared to the main camera 12, the sum of the fields of view of the binocular cameras 14 and 16 is usually larger. Therefore, the binocular images may be cropped according to the difference of the fields of view of the main camera 12 and the binocular cameras 14 and 16, such that the cropped images and the image captured by the main camera show the scene in the same field of view.

As another example, zoom factors of the main camera and/or the binocular cameras for the target scene may be determined first. Then, the registration may be performed on the image captured by the main camera and the binocular images according to differences between the zoom factors of the main camera and binocular cameras for the target scene.

For example, assume that the main camera 12 enlarges the target scene twice via a zoom function, but the binocular cameras 14 and 16 does not use or does not support the zoom function, then the image content of the image captured by the main camera 12 may be less than the image contents of the binocular images captured by the binocular cameras 14 and 16. In this scenario, the binocular images may be cropped, such that image contents of the cropped binocular images may match the image content of the image captured by the main camera 12.

Further, the registration manner of the images captured by the main camera 12 and the binocular cameras 14 and 16 may include a combination of the above manners, which is not repeated here.

The control device 18 may be configured to implement a control or information processing function in the process of using the binocular cameras 14 and 16 to assist the main camera 12 for the focus. The control device 18 may be a part of the main camera 12, for example, maybe implemented by the processor or the focus system of the main camera 12. Or, the control device 18 may be a part of the binocular cameras 14 and 16, for example, maybe implemented by a chip circuit of the binocular cameras 14 and 16. Or, the control device 18 may be an individual component external to the main camera 12 and the binocular cameras 14 and 16, for example, an individual processor or control device. In some other embodiments, the control device 18 may be a distributed control device, whose function may be implemented by a plurality of processors, which is not limited by embodiments of the present disclosure.

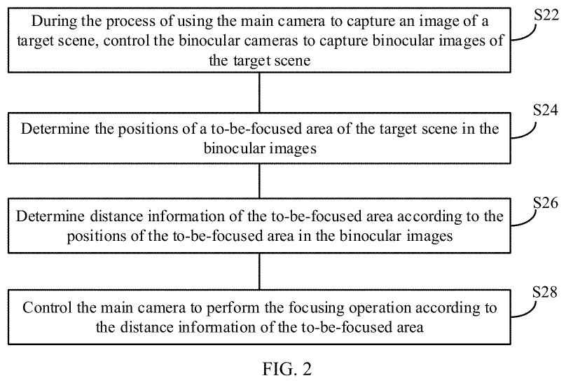

FIG. 2 is a schematic flowchart showing a focus method according to some embodiments of the present disclosure. The method in FIG. 2 can be executed by, e.g., the control device 18. The method in FIG. 2 includes process S22 to S28, which are described in detail below.

At S22, during the process of using the main camera 12 to capture an image of a target scene, the binocular cameras 14 and 16 are controlled to capture binocular images of the target scene.

The process of the main camera 12 capturing the image of the target scene can refer to the process of aiming the lens of the main camera 12 at the target scene to get ready for photographing the target scene.

The binocular images may include a left-eye image and a right-eye image. Parallax may exist between the binocular images. A parallax map of the target scene may be obtained based on the parallax between the binocular images to obtain the depth map of the target scene.

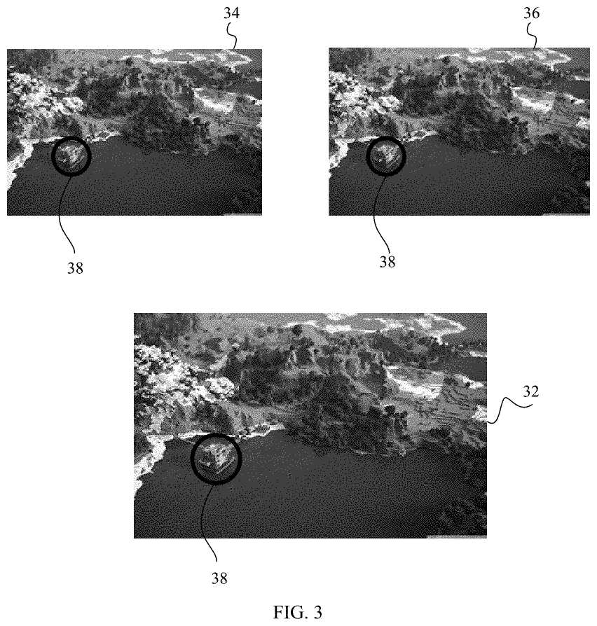

For example, the target scene is a landscape scene as shown in FIG. 3, the image captured by the main camera 12 is an image 32 in FIG. 3, and the binocular images captured by the binocular cameras 14 and 16 include a left-eye image 34 and a right-eye image 36. As shown in FIG. 3, because the positions of the main camera 12 and the binocular cameras 14 and 16 are different, certain parallaxes exist between the image 32 and the binocular images 34 and 36. However, the parallaxes between the three images are very small, the objects shown in FIG. 32 appear in the binocular images 34 and 36. The small parallaxes may not have a great influence on the realization of the subsequent auxiliary focusing function.

At S24, the positions of a to-be-focused area of the target scene in the binocular images are determined.

The to-be-focused area can refer to an area, on which the main camera 12 or the user wants to focus. As an implementation manner, input information of a user may be received. The input information may be used to select the to-be-focused area in the image captured by the main camera 12. For example, the main camera 12 may include an LCD screen configured to display the image. The user may select the to-be-focused area in the image captured by the main camera 12 via touch or button. For example, the user may select the to-be-focused area in the image captured by the main camera 12 by clicking. As another example, the user may delineate an area as the to-be-focused area in the image captured by the main camera 12 by a sliding operation.

The to-be-focused area may sometimes be referred to as a to-be-focused point (target point) or a to-be-focused position (target position). The to-be-focused area may usually include the object that the user wants to focus on. Therefore, in some embodiments, the to-be-focused area may be replaced with a to-be-focused object (target object).

In some other embodiments, the to-be-focused area may be pre-set for the camera device 10, and the user does not need to select. For example, the camera device 10 may be a camera device carried by an unmanned aerial vehicle (UAV), which may be configured to detect an unknown scene to find whether a target object (e.g., human or another object) exists. Thus, the to-be-focused area of the camera device 10 may be pre-set as the area where the target object is located. As soon as the target object is detected, the camera device 10 may automatically focus on the area where the target object is located to photograph the target object.

The positions of the to-be-focused area in the binocular images may include the position of the to-be-focused area in the left-eye image, the position of the to-be-focused area in the right-eye image, or both positions of the to-be-focused area in the left-eye image and the right-eye image.

The process S24 may be implemented in one of a plurality of manners. For example, the position of the to-be-focused area in the binocular images may be determined according to the relative position relationship between the main camera 12 and the binocular cameras 14 and 16. The positions of the to-be-focused area in the binocular images may also be recognized by a semantic recognition manner. Implementations of the process S24 are described in detail in connection with specific embodiments below, which are not detailed here.

At S26, distance information of the to-be-focused area is determined according to the positions of the to-be-focused area in the binocular images.

The distance information of the to-be-focused area may also be referred to as depth information of the to-be-focused area. The distance information of the to-be-focused area may be used to indicate a distance between the to-be-focused area and the camera device 10 (or the main camera 12, or the binocular cameras 14 and 16).

The process S26 may be implemented by a plurality of manners. For example, the depth map of the target scene may be generated according to the binocular images first. Then, a corresponding position of the to-be-focused area in the depth map may be determined according to the positions of the to-be-focused area in the binocular images. Then, the depth information corresponding to the position may be read from the depth map and used as the distance information of the to-be-focused area.

As another example, the positions of the to-be-focused area in the left-eye image and the right-eye image may be determined first. Then, the registration may be performed on the positions of the to-be-focused area in the left-eye image and the right-eye image according to the parallax between the left-eye image and the right-eye image to determine the distance information corresponding to the positions.

As shown in FIG. 3, assume that the main camera 12 wants to focus on a small tower 38 in the image 32, thus, the area, where the small tower 38 is, is the to-be-focused area. Since the small tower 38 also appears in the left-eye image 34 and the right-eye image 36, the positions of the area, where the small tower 38 is, in the left-eye image 34 and the right-eye image 36 may be calculated first. Then, the distance information of the area, where the small tower 38 is, may be determined according to the parallax of the left-eye image 34 and the right-eye image 36.

At S28, the main camera 12 is controlled to perform the focusing operation according to the distance information of the to-be-focused area.

In embodiments of the present disclosure, the implementations of the process S28 are not limited. For example, the position of the focal point may be determined according to the distance information of the to-be-focused area, and then the camera lens of the main camera 12 may be controlled to move to the position of the focal point. In some embodiments, the position of the focal point determined based on the distance information of the to-be-focused area may be used as an approximate position of the focal point. Then, the CDAF may be performed near the position by using the CDAF manner to find the accurate position of the focal point.

In embodiments of the present disclosure, the binocular cameras 14 and 16 may provide the distance information of the to-be-focused area for the main camera 12, such that the main camera 12 may perform the focus with a known distance of the to-be-focused area. Compared to the CDAF manner, the focus speed may be improved. Further, the focus method provided by embodiments of the present disclosure may not largely rely on the strength of the optical signal received by the phase focal point like the PDAF manner. Therefore, a good focus effect may also be achieved in a dark environment. In summary, the focus method of embodiments of the present disclosure may overcome deficiencies of the convention focus method in some aspects and take both the focus effect and the focus speed into account. Further, the focus method provided by embodiments of the present disclosure may continuously follow the distance of the to-be-focused area. Therefore, the focus method of embodiments of the present disclosure is suitable for achieving the follow focus.

The implementations of the process S24 (i.e., the determination manner of the positions of the to-be-focused area in the binocular images) are described in detail with examples.

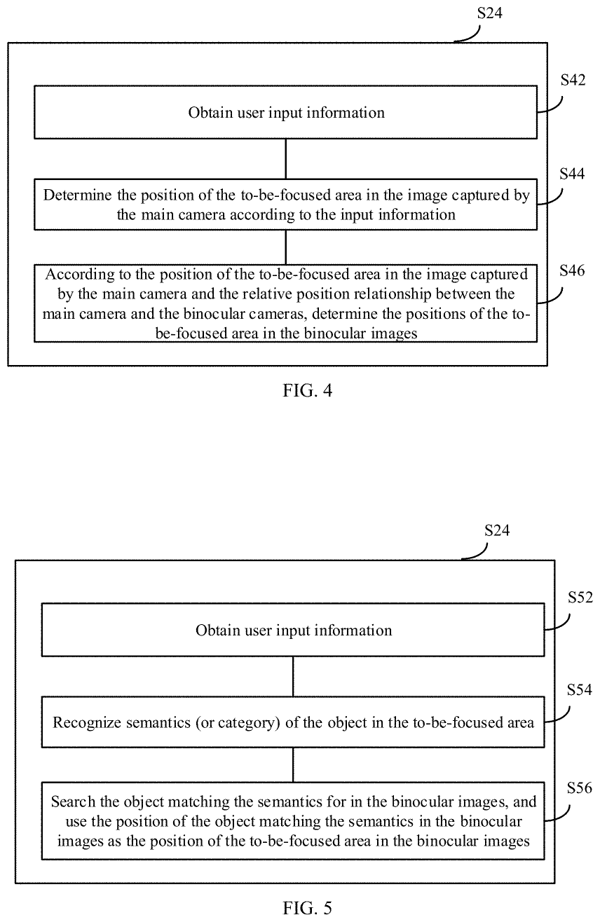

FIG. 4 is a schematic flowchart of a possible implementation of process S24 in FIG. 2. FIG. 4 describes mainly how to determine the positions of the to-be-focused area in the binocular images based on the relative position relationship between the main camera 12 and the binocular cameras 14 and 16. As shown in FIG. 4, the process S24 may include processes S42 to S46.

At S42, user input information is obtained.

The input information may be used to select the to-be-focused area from the image captured by the main camera 12. For example, the main camera 12 may include the LCD screen configured to display the image. The user may select the to-be-focused area from the image on the LCD screen by touch or button.

At S44, the position of the to-be-focused area in the image captured by the main camera is determined according to the input information.

For example, the position in the image captured by the main camera 12 corresponding to the user touch position on the touch screen of the main camera 12 may be determined as the position of the to-be-focused area in the image captured by the main camera 12.

At S46, according to the position of the to-be-focused area in the image captured by the main camera 12 and the relative position relationship between the main camera 12 and the binocular cameras 14 and 16, the positions of the to-be-focused area in the binocular images are determined.

The relative position relationship between the main camera 12 and the binocular cameras 14 and 16 may be pre-obtained. For example, the camera coordinate system of the main camera 12 and binocular cameras 14 and 16 can be pre-calibrated to calculate a conversion matrix for the camera coordinate systems of the main camera 12 and the binocular cameras 14 and 16. The conversion matrix may be used to represent the relative position relationship between the main camera 12 and the binocular cameras 14 and 16.

FIG. 5 is a schematic flowchart of another possible implementation of process S24 in FIG. 2. Different from the implementation in FIG. 4, FIG. 5 describes mainly how to recognize and locate the to-be-focused area based on the image processing algorithm. As shown in FIG. 5, the process S24 includes processes S52 to S56.

At S52, user input information is obtained.

The input information may be used to select the to-be-focused area from the image captured by the main camera 12. For example, the main camera 12 may include the LCD screen configured to display the image. The user may select the to-be-focused area from the image displayed on the LCD screen by touch or button.

At S54, semantics (or category) of the object in the to-be-focused area is recognized.

In embodiments of the present disclosure, the semantic recognition manner for the object in the to-be-focused area is not limited. The semantic recognition may be performed based on an image classification algorithm or based on a neural network model.

The semantic recognition process based on the image classification algorithm, for example, may be implemented by the following methods. An image feature in the to-be-focused area may be first extracted by methods of scale-invariant feature transform (SIFT), histogram of oriented gradient (HOG), etc. Then, the extracted image feature may be entered into a classification model, such as a support vector machine (SVM), K nearest, etc., to determine the semantics of the object in the to-be-focused area.

The semantic recognition process based on the neural network model, for example, may be implemented by one of the following methods. The image feature of the to-be-focused area may be extracted by using a first neural network model (a plurality of convolutional layers may be used to extract the image feature or a combination of the convolutional layers and pooling layers may be used to extract the image feature). Then, the image feature may be output to the classification module (e.g., SVM module) to obtain the semantics of the object in the to-be-focused area. In some embodiments, the image feature of the to-be-focused area may be first extracted by using the feature extraction layer (the feature extraction layer, for example, may include the convolutional layers or the convolutional layers and the pooling layers) of the first neural network model. Then, the image feature may be entered into a fully connected layer of the neural network. The fully connected layer may calculate a probability of each pre-set candidate semantics (or candidate category), and the semantics with the largest probability may be used as the semantics of the object of the to-be-focused area.

In embodiments of the present disclosure, the type of the first neural network model is not limited. For example, the first neural network model may include a convolutional neural network (CNN), GoogleNet, or VGG.

At S56, the object matching the semantics is searched for in the binocular images, and the position of the object matching the semantics in the binocular images is used as the position of the to-be-focused area in the binocular images.

In embodiments of the present disclosure, the semantic recognition manner is used to determine the position of the to-be-focused area in the binocular images. Such an implementation manner does not need to accurately calibrate the main camera 12 and the binocular cameras 14 and 16 (rough calibration is enough), which simplifies the camera device.

In embodiments of the present disclosure, the implementation manners of the process S56 are not limited. For example, the process S56 may be implemented by using a feature matching algorithm. For example, the feature of the object corresponding to the semantics may be pre-stored. In actual matching, the binocular images may be divided into a plurality of image blocks first. Then, a feature of each image block may be extracted. The object in the image block with the most matching feature may be used as the object matching the semantics, and the position of the image block may be used as the position of the to-be-focused area in the binocular images.

As another example, the object matching the semantics may be searched for in the binocular images according to a pre-trained second neural network model.

For example, the second neural network model may be trained by using the image including the to-be-focused area, such that the neural network model may recognize the to-be-focused area from the image and output the position of the to-be-focused area in the image. Then, in practical applications, the binocular images may be entered to the second neural network model to determine the positions of the to-be-focused area in the binocular images.

Take FIG. 3 as an example, the second neuro network mode may be pre-trained, such that the second network model may recognize the small tower. In practical applications, the binocular images may be entered to the second neural network model to determine the positions of the small tower 38 in the binocular images.

The second neural network model may include a feature extraction layer and a fully connected layer. The feature extraction layer, for example, may include the convolutional layers or the convolutional layers and the pooling layers. The input of the fully connected layer may include the feature extracted by the feature extraction layer, and the output of the fully connected layer may include the position of the object matching the semantics in the binocular images. The specific implementation manner of the second neural network model may be designed with reference to a design method of a neural network model having an image recognition and positioning function, for example, may be designed with reference to the design method of the CNN model based on a sliding window.

Under some situations, the images captured by the main camera 12 and the binocular cameras 14 and 16 may include a plurality of objects having the same semantics. To improve robustness of the algorithm, in embodiments shown in FIG. 5, the approximate position range of the to-be-focused area selected by the user in the image captured by the main camera 12 may be obtained. The object matching the semantics may be searched in the range of the binocular images corresponding to the approximate position range. As such, error probability may be reduced.

All or a part of the above embodiments may be implemented by software, hardware, firmware, or a combination thereof. When implemented by software, all or a part of the above embodiments may be implemented in the form of a computer program product. The computer program product may include one or more computer instructions. When the computer program instructions are loaded and executed on the computer, all or a part of the processes or functions described in embodiments of the present disclosure may be generated. The computer may include a general-purpose computer, a special-purpose computer, a computer network, or other programmable devices. The computer instructions may be stored in a computer-readable storage medium or transmitted from one computer-readable storage medium to another computer-readable storage medium. For example, the computer instructions may be transmitted from a website, computer, server, or data center to another website, computer, server, or data center via a wired (such as coaxial cable, optical fiber, digital subscriber line (DSL)) or wireless (such as infrared, wireless, microwave, etc.) manner. The computer-readable storage medium may include any available medium that can be accessed by a computer or a data storage device such as a server, a data center, etc., integrated with one or more available media. The available media may include a magnetic medium (e.g., a floppy disk, a hard disk, a magnetic tape), an optical medium (e.g., a digital video disc (DVD)), or a semiconductor medium (e.g., a solid-state disk (SSD)), etc.

Those of ordinary skill in the art may be aware that the units and algorithm processes of the examples described in embodiments of the present disclosure may be implemented by electronic hardware or a combination of computer software and electronic hardware. Whether these functions are executed by hardware or software depends on the specific application and design constraint conditions of the technical solution. Those skilled in the art may use different methods for each specific application to implement the described functions, but such implementation should not be considered beyond the scope of the present disclosure.

In some embodiments of the present disclosure, the disclosed system, device, and method may be implemented in other manners. For example, device embodiments described above are merely illustrative. For example, the division of the units is only a logic functional division, and other divisions may exist in actual implementation. For example, multiple units or components may be combined or integrated into another system, or some features may be ignored or not implemented. In addition, the displayed or discussed mutual coupling or direct coupling or communication connection may be indirect coupling or communication connection through some interfaces, devices, or units, and may be in electrical, mechanical, or other forms.

The units described as separate components may or may not be physically separated, and the components displayed as units may or may not be physical units, that is, they may be located in one place, or they may be distributed at multiple network units. Some or all of the units may be selected according to actual needs to achieve the objectives of the solutions of embodiments of the present disclosure.

In addition, the functional units in various embodiments of the present disclosure may be integrated into one processing unit, or each unit may exist alone physically, or two or more units may be integrated into one unit.

Specific embodiments of the present disclosure are described above. However, the scope of the present disclosure is not limited to these embodiments. Those skilled in the art may easily think of changes or replacements within the technical scope disclosed in the present disclosure, which should be within the scope of the present disclosure. Therefore, the scope of the present invention should be subject to the scope of the claims.

What is claimed is:

1. A focus method comprising:
controlling binocular cameras of a camera device to capture binocular images of a target scene during a process of photographing the target scene using a main camera of the camera device;
determining positions of a target area of the target scene in the binocular images;
determining distance information of the target area according to the positions of the target area in the binocular images; and
controlling the main camera to perform focus according to the distance information of the target area.

2. The method of claim 1, wherein determining the positions of the target area of the target scene in the binocular images includes:
obtaining input information, the input information being used to select the target area from a main image captured by the main camera;
determining a position of the target area in the main image; and
determining the positions of the target area in the binocular images according to the position of the target area in the main image and relative position relationship between the main camera and the binocular cameras.

3. The method of claim 2, wherein the relative position relationship between the main camera and the binocular cameras is represented by a pre-calibrated camera coordinate system conversion matrix for the main camera and the binocular cameras.

4. The method of claim 1, wherein determining the positions of the target area of the target scene in the binocular images includes:
obtaining input information, the input information being used to select the target area from a main image captured by the main camera;
recognizing semantics of an object in the target area; and
searching for a matching object matching the semantics in the binocular images and using positions of the matching object in the binocular images as the positions of the target area in the binocular images.

5. The method of claim 4, wherein recognizing the semantics of the object in the target area includes:
recognizing the semantics of the object in the target area according to a pre-trained neural network model.

6. The method of claim 4, wherein searching for the matching object in the binocular images includes:
searching for the matching object in the binocular images according to a pre-trained neural network model.

7. The method of claim 1, further comprising, before determining the positions of the target area of the target scene in the binocular images:
performing registration on a main image captured by the main camera and the binocular images according to differences between fields of view of the main camera and the binocular cameras.

8. The method of claim 1, further comprising, before determining the positions of the target area of the target scene in the binocular images:
determining a zoom factor of the main camera with respect to the target scene; and
performing registration on a main image captured by the main camera and the binocular images according to differences between zoom factors of the main camera and the binocular cameras with respect to the target scene.

9. The method of claim 1, wherein:
the binocular cameras and the main camera are integrated at the camera device; or
the binocular cameras and the main camera are detachably connected at the camera device.

10. A camera device comprising:
a main camera;
binocular cameras; and
a control device configured to:
control the binocular cameras to capture binocular images of a target scene during a process of photographing the target scene using the main camera;
determine positions of a target area of the target scene in the binocular images;
determine distance information of the target area according to the positions of the target area in the binocular images; and
control the main camera to perform focus according to the distance information of the target area.

11. The device of claim 10, wherein the control device is further configured to:
obtain input information, the input information being used to select the target area from a main image captured by the main camera;
determine a position of the target area in the main image; and
determine the positions of the target area in the binocular images according to the position of the target area in the main image and relative position relationship between the main camera and the binocular cameras.

12. The device of claim 11, wherein:
the relative position relationship between the main camera and the binocular cameras is represented by a pre-calibrated coordinate system conversion matrix for the main camera and the binocular cameras.

13. The device of claim 10, wherein the control device is further configured to:
obtain input information, the input information being used to select the target area from a main image captured by the main camera;
recognize semantics of an object in the target area; and
search for a matching object matching the semantics in the binocular images and use positions of the matching object in the binocular images as the positions of the target area in the binocular images.

14. The device of claim 13, wherein the control device is further configured to:
recognize the semantic of the object in the target area according to a pre-trained neural network model.

15. The device of claim 13, wherein the control device is further configured to:
search for the matching object in the binocular images according to a pre-trained neural network model.

16. The device of claim 10, wherein the control device is further configured to:
perform registration on a main image captured by the main camera and the binocular images according to differences of fields of view between the main camera and the binocular cameras.

17. The device of claim 10, wherein the control device is further configured to:
determine a zoom factor of the main camera with respect to the target scene; and
perform registration on a main image captured by the main camera and the binocular images according to differences between zoom factors of the main camera and the binocular cameras with respect to the target scene.

18. The device of claim 10, wherein:
the binocular cameras and the main camera are integrated at the camera device; or
the binocular cameras and the main camera are detachably connected at the camera device.
